(19) United States
(12) Patent Application Publication
(10) Pub. No.: US 2024/0396356 A1
(43) Pub. Date: Nov. 28, 2024

(54) SOURCE DEVICE

(71) Applicant: ROHM CO., LTD., Kyoto-shi (JP)

(72) Inventor: Nobutaka ITAKURA, Kyoto-shi (JP)

(21) Appl. No.: 18/667,054

(22) Filed: May 17, 2024

(30) Foreign Application Priority Data
May 24, 2023 (JP) 2023-085396

(51) Int. Cl. H02J 7/00

(52) U.S. Cl. CPC H02J 7/007182; H02J 7/0047; H02J 7/007188; H02J 2207/30

(57) ABSTRACT

A source device for supplying power to a sink device includes: a first terminal through which a current to the sink device flows when the first terminal is coupled to the sink device; a second terminal through which a current to a cable for identifying the cable flows when the second terminal is coupled to the cable; detection circuit configured to detect that the first terminal is coupled to the sink device based on a voltage according to the current flowing through the first terminal; and a current control circuit configured to control a magnitude of the current flowing through the first terminal or a magnitude of the current flowing through the second terminal in response to the detection circuit detecting that the first terminal is coupled to the sink device.

### CROSS REFERENCE TO RELATED APPLICATIONS

The present invention claims priority under 35 U.S.C. § 119 to Japanese Application No. 2023-085396, filed on May 24, 2023, the entire contents of which being incorporated herein by reference.

### BACKGROUND

### 1. Technical Field

The present disclosure relates to a source device.

### 2. Description of the Related Art

Various devices such as a smartphone and a tablet terminal can operate according to power supplied from the outside. By coupling a source device that supplies power to the device, power can be supplied to the device. For example, Japanese Patent Application (Laid Open) No. 2023-43758 describes that a sink device and a source device compatible with a universal serial bus (USB)-Type C are coupled to charge the sink device.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a schematic block diagram of a power feeding system according to an embodiment of the present disclosure,

FIG. 2 is a schematic block diagram of a CC circuit of a source device, a sink CC circuit of a sink device, and a cable according to a comparative technique,

FIG. 3 is a diagram illustrating a source CC circuit and a cable when the sink device is not coupled to the source device in the comparative technique,

FIG. 4 is a schematic block diagram of a source CC circuit according to the embodiment of the present disclosure,

FIG. 5 is a diagram for describing an example of an operation of the source CC circuit when a cable is coupled to the source device according to the embodiment,

FIG. 6 is a diagram for describing an example of an operation of the source CC circuit and the sink CC circuit when the source device according to the embodiment is coupled to the sink device via the cable; and

FIG. 7 is a diagram illustrating a timing chart for describing an example of an operation of the source CC circuit according to an example and a comparative example.

### DETAILED DESCRIPTION

An overview of some exemplary embodiments of the present disclosure will be described. This overview describes some concepts of one or more embodiments in a simplified manner for the purpose of basic understanding of the embodiment as a prelude to the detailed description that follows and does not limit the breadth of the invention or disclosure. This overview is not a comprehensive overview of all possible embodiments and is not intended to identify key elements of all embodiments or delineate the scope of some or all aspects. For convenience, “an embodiment” may be used to refer to one embodiment (example or modification) or a plurality of embodiments (example or modification) disclosed in the present specification.

A source device according to an embodiment supplies power to a sink device. The source device includes a first terminal through which a current to the sink device flows when the first terminal is coupled to the sink device; a second terminal through which a current to a cable for identifying the cable flows when the second terminal is coupled to the cable; a detection circuit configured to detect that the first terminal is coupled to the sink device based on a voltage according to the current flowing through the first terminal; and a current control circuit configured to control a magnitude of the current flowing through the first terminal or a magnitude of the current flowing through the second terminal in response to the detection circuit detecting that the first terminal is coupled to the sink device.

According to this configuration, the current flowing through the first terminal or the second terminal is reduced before coupling between the source device and the sink device, and in a case where the source device and the sink device are coupled, the current flowing through the first terminal or the second terminal can be made to a necessary magnitude. As a result, it is possible to reduce power consumption in the operation of the source device before the coupling between the source device and the sink device.

In an embodiment, when the first terminal is coupled to the sink device via the cable and the second terminal is coupled to the cable, the current control circuit may increase the current flowing through the second terminal such that the source device can identify the cable in response to the detection circuit detecting that the first terminal is coupled to the sink device.

In an embodiment, the current control circuit may increase the current flowing through the first terminal such that the sink device can recognize the source device in response to the detection circuit detecting that the first terminal is coupled to the sink device.

In an embodiment, the first terminal may be a terminal through which a current to the sink device flows when the first terminal is coupled to the sink device. The second terminal may be a terminal through which a current to the cable for identifying the cable flows when the second terminal is coupled to the cable. The detection circuit may detect that the second terminal is coupled to the sink device based on a voltage according to the current flowing through the second terminal. The current control circuit may control the magnitude of the current flowing through the first terminal or the magnitude of the current flowing through the second terminal in response to the detection circuit detecting that the second terminal is coupled to the sink device.

In an embodiment, the source device may further include a first current source that supplies a current to the first terminal and a second current source that supplies a current to the second terminal. The current control circuit may control a magnitude of the current supplied from the first current source to the first terminal or a magnitude of the current supplied from the second current source to the second terminal in response to the detection circuit detecting that the first terminal is coupled to the sink device.

### Embodiment

Hereinafter, a preferred embodiment will be described with reference to the drawings. The same or equivalent components, members, and processing illustrated in the drawings are denoted by the same reference numerals, and redundant description will be omitted as appropriate. Further, the embodiment is not intended to limit the disclosure and the invention, but is merely an example, and all features described in the embodiment and combinations thereof are not necessarily essential to the disclosure and the invention.

In the present specification, “a state in which a member A is coupled to a member B” includes not only a case where the member A and the member B are physically and directly coupled to each other, but also a case where the member A and the member B are indirectly coupled to each other via another member which does not substantially affect an electrical coupling state between the member A and the member B or which does not impair a function or an effect exhibited by coupling between the member A and the member B.

Similarly, “a state where a member C is coupled (provided) between the member A and the member B” includes not only a case where the member A and the member C, or the member B and the member C are directly coupled to each other, but also a case where the members are indirectly coupled to each other via another member which does not substantially affect an electrical coupling state between the members or which does not impair a function or an effect exhibited by the coupling between the members.

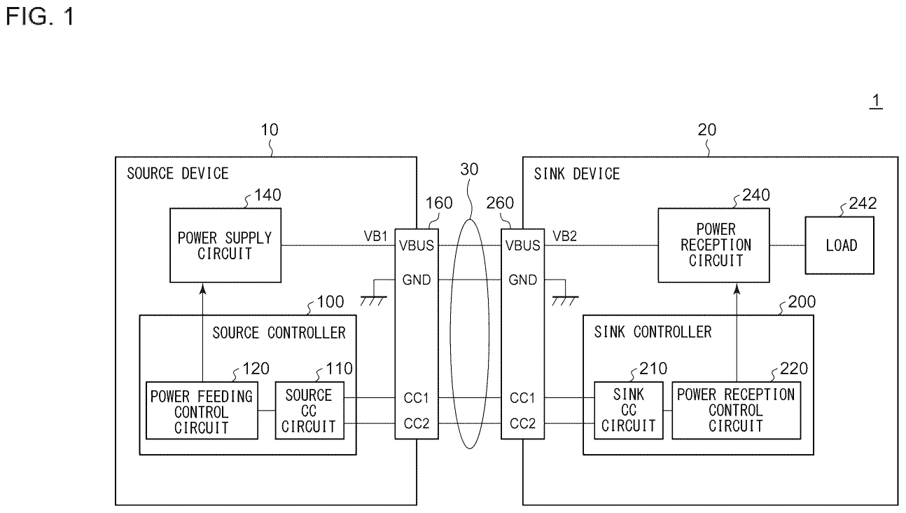

FIG. 1 is a schematic block diagram of a power feeding system 1 according to an embodiment of the present disclosure. The power feeding system 1 according to the present embodiment is compliant with the USB-Type C standard and includes a source device 10 and a sink device 20 coupled via a cable 30 that is a USB cable.

The source device 10 has a function of supplying power to the sink device 20. The source device 10 includes a source controller 100, a power supply circuit 140, and a source port 160. The cable 30 is detachably coupled to the source port 160.

The source port 160 includes a VBUS terminal for supplying a bus voltage VB1, a GND terminal to which a ground potential is supplied, a CC1 terminal, and a CC2 terminal. Hereinafter, when the CC1 terminal and the CC2 terminal are not distinguished from each other, they are also simply referred to as CC terminals.

The power supply circuit 140 generates the bus voltage VB1. The power supply circuit 140 may have an A/D converter that receives an AC voltage from an external power supply (not illustrated) (for example, a commercial AC power supply) and converts the voltage into a DC bus voltage VB1. The bus voltage VB1 is supplied to the sink device 20 via a bus line of the cable 30.

The source controller 100 is a controller related to USB-Type C. The source controller 100 may be configured by, for example, an integrated circuit (IC). The source controller 100 has a source CC circuit 110 and a power feeding control circuit 120.

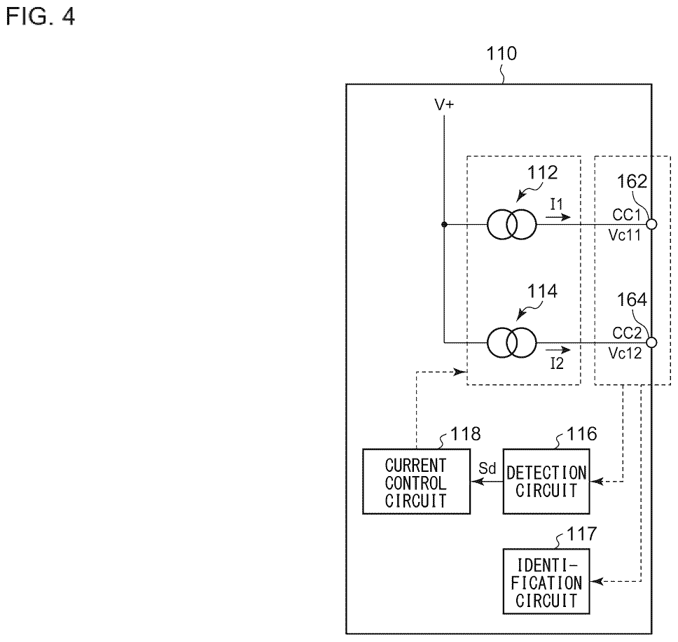

The source CC circuit 110 is coupled to the CC1 terminal and the CC2 terminal of the source port 160. The source CC circuit 110 supplies a current to the CC1 terminal and the CC2 terminal and performs various types of detection based on the voltages of the CC1 terminal and the CC2 terminal. The source CC circuit 110 may transmit the detection result to the power feeding control circuit 120. A specific configuration and function of the source CC circuit 110 will be described later with reference to FIG. 4.

The power feeding control circuit 120 controls an operation of the power supply circuit 140 based on the detection result of the source CC circuit 110 and the like. For example, the power feeding control circuit 120 may control the power supply circuit 140 such that the power supply circuit 140 supplies the bus voltage VB1 in response to the detection that the source device 10 is coupled to the sink device 20.

The sink device 20 is a device that operates based on a bus voltage VB2 according to the bus voltage VB1 of the source device 10. The sink device 20 includes a sink controller 200, a power reception circuit 240, a load 242, and a sink port 260. The cable 30 is detachably coupled to the sink port 260.

The sink port 260 includes a VBUS terminal, a GND terminal to which a ground potential is supplied, a CC1 terminal, and a CC2 terminal. The bus voltage VB2 according to the bus voltage VB1 of the source device 10 is input to the VBUS terminal.

The power reception circuit 240 receives the bus voltage VB2 from the VBUS terminal. The power reception circuit 240 may supply power to the load 242 or charge a battery (not illustrated) using the bus voltage VB2.

The sink controller 200 is a port controller related to the USB-Type C. The sink controller 200 may be configured by, for example, an IC. The sink controller 200 has a sink CC circuit 210 and a power reception control circuit 220.

The sink CC circuit 210 is coupled to the CC1 terminal and the CC2 terminal of the sink port 260. The sink CC circuit 210 measures the voltages of the CC1 terminal and the CC2 terminal and performs various types of detection. The sink CC circuit 210 may transmit the detection result to the power reception control circuit 220.

The power reception control circuit 220 controls the operation of the power reception circuit 240 based on the detection result of the sink CC circuit 210 and the like. For example, the power reception control circuit 220 may control the power reception circuit 240 such that the power reception circuit 240 operates according to the bus voltage VB2 in response to the detection that the sink device 20 is coupled to the source device 10.

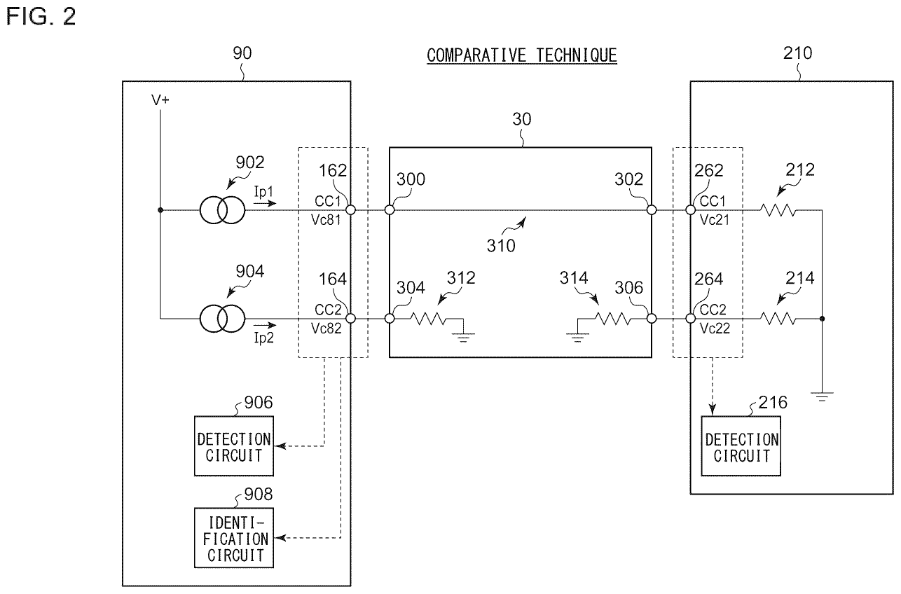

Before describing the detailed configuration of the source device 10 according to the present embodiment, an example in which the source CC circuit 110 according to the present embodiment is replaced with a source CC circuit 90 according to a comparative technique will be described with reference to FIG. 2. FIG. 2 is a schematic block diagram of the source CC circuit 90 of the source device, the sink CC circuit 210 of the sink device 20, and the cable 30 according to the comparative technique.

The source CC circuit 90 according to the comparative technique has a first current source 902, a second current source 904, a detection circuit 906, and an identification circuit 908. Hereinafter, when the first current source and the second current source are not distinguished from each other, they are also simply referred to as current sources.

The first current source 902 is provided such that a power supply voltage V+ is supplied to one end and a CC1 terminal 162 of the source port 160 is coupled to the other end. The first current source 902 is configured to cause a current Ip1 to flow to the CC1 terminal 162 when the source device is coupled to the sink device 20. A current value Ip of the current Ip1 is a value defined in the USB-Type C standard. Specifically, the current value Ip may be any of 80 μA, 180 μA, or 330 μA according to the standard.

The second current source 904 is provided such that the power supply voltage V+ is supplied to one end and a CC2 terminal 164 of the source port 160 is coupled to the other end. The second current source 904 is configured to cause a current Ip2 to flow to the CC2 terminal 164 when the source device is coupled to the cable 30. A current value Ip of the current Ip2 is a value defined in the USB-Type C standard. Similarly to the current value Ip of the current Ip1, the current value Ip may be any one of 80 μA, 180 μA, or 330 μA according to the standard.

The detection circuit 906 detects coupling or the like between the source device and the sink device 20 based on a voltage Vc81 of the CC1 terminal 162 or a voltage Vc82 of the CC2 terminal. For example, the detection circuit 906 can detect that the CC1 terminal 162 is coupled to the sink device 20 based on the voltage Vc81 of the CC1 terminal 162.

The identification circuit 908 may identify a type of the cable 30 coupled to the CC2 terminal 164 based on the voltage Vc81 of the CC1 terminal 162 or the voltage Vc82 of the CC2 terminal. For example, the identification circuit 908 can identify that the cable 30 is an electronic marked cable or the like based on the voltage Vc82 of the CC2 terminal.

The sink CC circuit 210 has a first resistor 212, a second resistor 214, and a detection circuit 216. The first resistor 212 and the second resistor 214 are pull-down resistors each having a predetermined resistance value [Rd].

The first resistor 212 is provided such that one end is coupled to a CC1 terminal 262 of the sink port 260 and the ground potential is supplied to the other end. The second resistor 214 is provided such that one end is coupled to a CC2 terminal 264 of the sink port 260 and the ground potential is supplied to the other end.

The detection circuit 216 performs detection based on a voltage Vc21 of the CC1 terminal 262 and a voltage Vc22 of the CC2 terminal 264. Specifically, the detection circuit 216 may detect that the sink device 20 is coupled to the source device (specifically, the CC1 terminal 262 is coupled to the CC1 terminal 162 via the cable 30) based on the voltage Vc21 of the CC1 terminal 262.

The cable 30 has a first terminal 300, a second terminal 302, a third terminal 304, a fourth terminal 306, a CC line 310, a third resistor 312, and a fourth resistor 314. The third resistor 312 and the fourth resistor 314 each have a predetermined resistance value [Ra].

The CC line 310 is provided such that one end is coupled to the first terminal 300 and the other end is coupled to the second terminal 302. The third resistor 312 is provided such that one end is coupled to the third terminal 304 and the ground potential is supplied to the other end. The fourth resistor 314 is provided such that one end is coupled to the fourth terminal 306 and the ground potential is supplied to the other end.

In the example illustrated in FIG. 2, when the source device is coupled to the sink device 20 via the cable 30, the first terminal 300 of the cable 30 is coupled to the CC1 terminal 162 of the source device, and the second terminal 302 of the cable 30 is coupled to the CC1 terminal 262 of the sink device 20. In addition, the third terminal 304 of the cable 30 is coupled to the CC2 terminal 164 of the source device 10, and the fourth terminal 306 of the cable 30 is coupled to the CC2 terminal 264 of the sink device 20.

When the CC1 terminal 162 is not coupled to the sink device 20, the power supply voltage V+ is supplied to the CC1 terminal 162. When the CC1 terminal 162 is coupled to the sink device 20, the current Ip1 from the first current source 902 to the cable 30 flows through the CC1 terminal 162. The current Ip1 flows to the first resistor 212 of the sink CC circuit 210 via the CC line 310. As a result, the voltage Vc81 of the CC1 terminal 162 of the source device becomes a voltage (=Rd×Ip) of the first resistor 212. As a result, the voltage Vc81 of the CC1 terminal 162 of the source device decreases. The detection circuit 906 can detect that the CC1 terminal 162 is coupled to the sink device 20 in response to the decrease in a voltage Vc81 of the CC1 terminal 162.

Since the CC2 terminal 164 of the source device is coupled to the third terminal 304 of the cable 30, a current Ip2 from the second current source 904 to the cable 30 flows through the CC2 terminal 164. The current Ip2 flows through the third resistor 312, and a voltage Vc82 (=Ra×Ip) according to the current Ip2 and the third resistor 312 is generated at the CC2 terminal 164.

The identification circuit 908 can identify the type of the cable 30 based on the voltage Vc82. For example, the identification circuit 908 can identify that the cable 30 is an electronic marked cable that pulls down the third terminal 304 (VCONN terminal) coupled to one CC terminal (here, the CC2 terminal 164) of the CC1 terminal 162 and the CC2 terminal 164 of the source device. The source device can perform power transmission according to the identified type of the cable 30.

The sink device 20 can detect that the sink device 20 is coupled to the source device and the current capability of the source device based on the voltage Vc21 of the CC1 terminal 262. For example, the detection circuit 216 can detect that the sink device 20 is coupled to the source device in response to the voltage Vc21 exceeding a predetermined threshold. In addition, the detection circuit 216 can detect the current capability of the source device based on the magnitude of the voltage Vc21.

As described above, when the source device and the sink device 20 are coupled, the source device and the sink device 20 can detect information regarding the coupling and the like and operate according to the detection result.

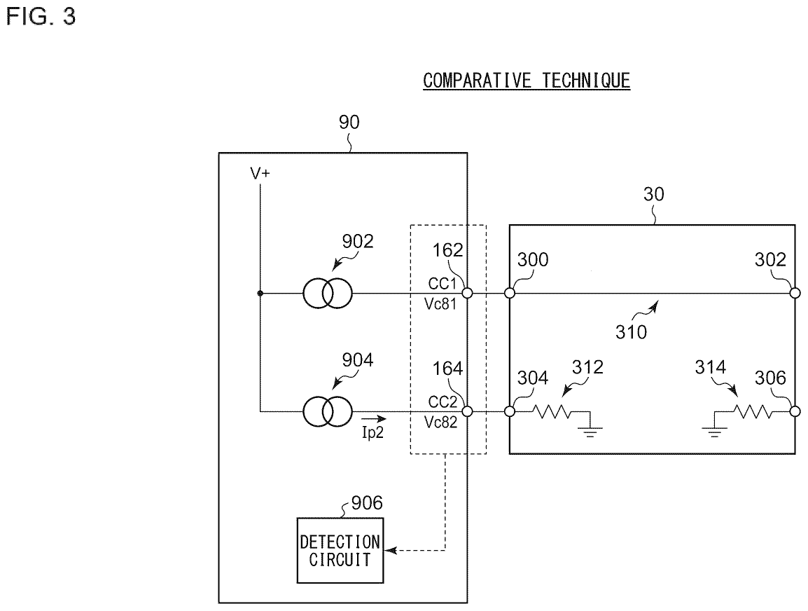

FIG. 3 is a diagram illustrating the source CC circuit 90 and the cable 30 when the sink device 20 is not coupled to the source device in the comparative technique.

When the sink device 20 is not coupled to the cable 30, the second terminal 302 of the cable 30 is opened, such that no current flows through the CC1 terminal 162. On the other hand, since the third resistor 312 of the cable 30 is coupled to the CC2 terminal 164, a current Ip2 from the second current source 904 to the third resistor 312 flows through the CC2 terminal 164. When the current Ip2 flows, power is consumed in the third resistor 312. However, since the source device is not coupled to the sink device 20, this power consumption is wasted. As described above, in the source device according to the comparative technique, unnecessary power consumption occurs due to the current Ip2 flowing through the cable 30 even though the source device is not coupled to the sink device 20.

Even in a case where the cable 30 is not coupled to the source device, when the CC1 terminal 162 and the CC2 terminal 164 are short-circuited due to water, dust, or the like, a current flows between the CC1 terminal 162 and the CC2 terminal 164, which causes power consumption. As described above, in the source device according to the comparative technique, unnecessary power consumption may occur even in a case where the source device is not coupled to the sink device 20.

The source device according to the comparative technique has been described above. FIG. 4 is a schematic block diagram of the source CC circuit 110 according to the embodiment of the present disclosure. The source CC circuit 110 according to the present embodiment has a first current source 112, a second current source 114, a detection circuit 116, an identification circuit 117, and a current control circuit 118.

The first current source 112 is provided such that the power supply voltage V+ is supplied to one end and the other end is coupled to the CC1 terminal 162 of the source port 160. The first current source 112 supplies a current I1 to the CC1 terminal 162. When the CC1 terminal 162 is coupled to the cable 30, the current I1 to the cable 30 for identifying the cable 30 flows from the first current source 112 to the CC1 terminal 162. Alternatively, in a case where the CC1 terminal 162 is coupled to the sink device 20 via the cable 30, the current I1 to the sink device 20 flows from the first current source 112 to the CC1 terminal 162. A magnitude of the current I1 may be, for example, a magnitude according to the USB-Type C standard, and may be specifically 80 μA, 180 μA, or 330 μA. The magnitude of the current I1 may be different from the USB-Type C standard, and may be lower than 80 μA, for example.

The second current source 114 is provided such that the power supply voltage V+ is supplied to one end and the other end is coupled to the CC2 terminal 164 of the source port 160. The second current source 114 supplies a current I2 to the CC2 terminal 164. When the CC2 terminal 164 is coupled to the cable 30, the current I2 to the cable 30 for identifying the cable 30 flows from the second current source 114 to the CC2 terminal 164. Alternatively, in a case where the CC2 terminal 164 is coupled to the sink device 20 via the cable 30, the current I2 to the sink device 20 flows from the second current source 114 to the CC2 terminal 164. A magnitude of the current I2 may be, for example, a magnitude according to the USB-Type C standard, and may be specifically 80 μA, 180 μA, or 330 μA. The magnitude of the current I2 may be different from the USB-Type C standard, and may be lower than 80 μA, for example.

The detection circuit 116 performs detection according to the voltage Vc11 of the CC1 terminal 162 or a voltage Vc12 of the CC2 terminal 164. For example, in a case where the CC1 terminal 162 is coupled to the sink device 20, the detection circuit 116 detects that the CC1 terminal 162 is coupled to the sink device 20 based on a voltage (specifically, the voltage Vc11 of the CC1 terminal 162) according to the current I1. Alternatively, in a case where the CC2 terminal 164 is coupled to the sink device 20, the detection circuit 116 detects that the CC2 terminal 164 is coupled to the sink device 20 based on a voltage (specifically, the voltage Vc12 of the CC2 terminal 164) according to the current I2. The detection circuit 116 transmits a signal Sd according to the detection result to the current control circuit 118.

The identification circuit 117 may identify the type of the cable 30 based on the voltage Vc11 of the CC1 terminal 162 or the voltage Vc12 of the CC2 terminal 164. For example, when the CC1 terminal 162 is coupled to the cable 30, the identification circuit 117 may identify the type (for example, an electronic marked cable or the like) of the cable 30 based on the voltage Vc11 of the CC1 terminal 162. More specifically, the identification circuit 117 may compare the voltage Vc11 with a predetermined threshold by a comparator and identify that the cable 30 is an electronic marked cable in a case where the voltage Vc11 is larger than a predetermined threshold. Note that the identification circuit 117 may identify that the cable 30 is not an electronic marked cable in a case where the voltage Vc11 is equal to or less than the predetermined threshold. Alternatively, when the CC2 terminal 164 is coupled to the cable 30, the identification circuit 117 may identify the type of the cable 30 based on the voltage Vc12 of the CC2 terminal 164. A signal according to the identification result of the identification circuit 117 may be transmitted to the power feeding control circuit 120.

The current control circuit 118 is configured to be able to control the magnitude of the current I1 flowing to the CC1 terminal 162 and the magnitude of the current I2 flowing to the CC2 terminal 164. The current control circuit 118 according to the present embodiment is configured to control the magnitude of the current I1 flowing through the CC1 terminal 162 or the magnitude of the current I2 flowing through the CC2 terminal 164 in response to the detection circuit 116 detecting that the CC1 terminal 162 or the CC2 terminal 164 is coupled to the sink device 20. In the present embodiment, the current control circuit 118 can control the magnitude of the current I1 flowing from the first current source 112 to the CC1 terminal 162 and the magnitude of the current I2 flowing from the second current source 114 to the CC2 terminal 164 according to the detection result of the detection circuit 116.

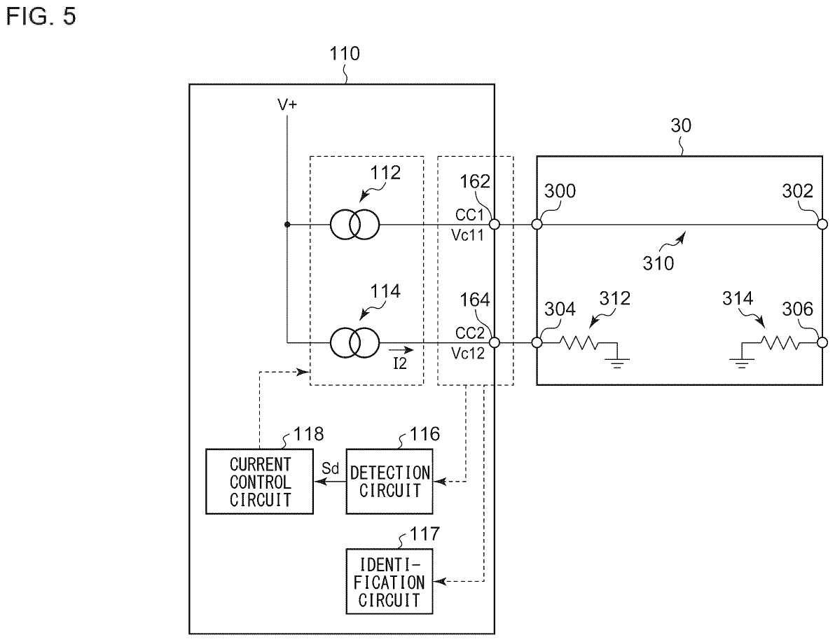

FIG. 5 is a diagram for describing an example of the operation of the source CC circuit 110 when the cable 30 is coupled to the source device 10 according to the present embodiment. Here, an example in which the CC1 terminal 162 of the source device 10 is coupled to the first terminal 300 of the cable 30 and the CC2 terminal 164 of the source device 10 is coupled to the third terminal 304 of the cable 30 will be described.

Since the second terminal 302 of the cable 30 is open, no current flows through the CC1 terminal 162. On the other hand, the current I2 from the second current source 114 to the third resistor 312 flows through the CC2 terminal 164. In the present embodiment, the current control circuit 118 can cause the current I2 flowing from the second current source 114 to be smaller (for example, a current value of 80 μA or less) than the currents Ip1 and Ip2 flowing from the first current source 902 and the second current source 904 of the source device according to the above-described comparative technique. As a result, power consumption in the third resistor 312 and the like can be reduced.

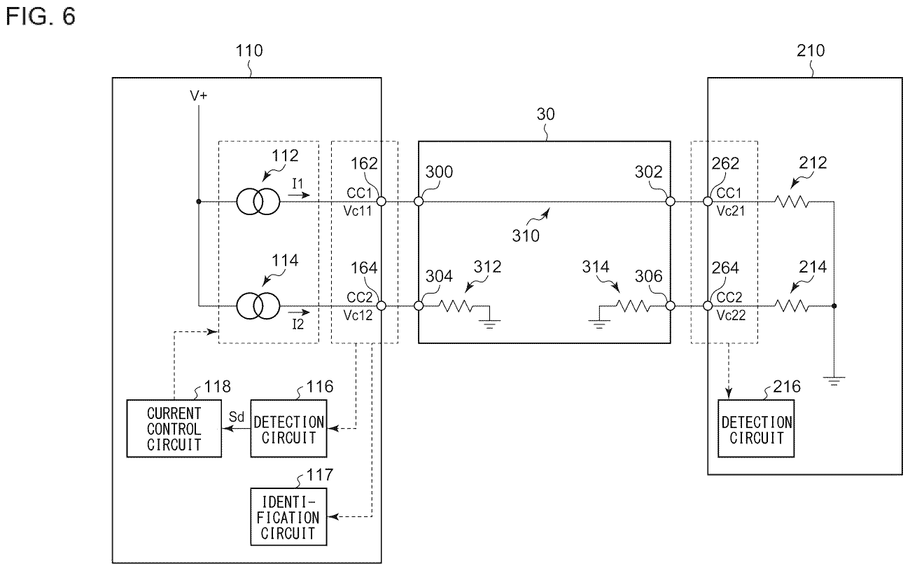

FIG. 6 is a diagram for describing an example of the operations of the source CC circuit 110 and the sink CC circuit 210 when the source device 10 according to the present embodiment is coupled to the sink device 20 via the cable 30. In the present embodiment, the first terminal 300 of the cable 30 is coupled to the CC1 terminal 162 of the source device 10, and the second terminal 302 of the cable 30 is coupled to the CC1 terminal 262 of the sink device 20. In addition, the third terminal 304 of the cable 30 is coupled to the CC2 terminal 164 of the source device 10, and the fourth terminal 306 of the cable 30 is coupled to the CC2 terminal 264 of the sink device 20.

The detection circuit 116 of the source device 10 can detect that the CC1 terminal 162 is coupled to the sink device 20 (specifically, the CC1 terminal 262) based on the voltage Vc11 of the CC1 terminal 162. When the CC1 terminal 162 is not coupled to the sink device 20, the current I1 does not flow from the first current source 112 to the CC1 terminal 162, and the power supply voltage V+ is supplied to the CC1 terminal 162. When the CC1 terminal 162 is coupled to the sink device 20, the current I1 flows from the first current source 112 to the CC1 terminal 162. The current I1 flows to the first resistor 212 of the sink CC circuit 210 via the CC line 310 of the cable 30. As a result, the voltage Vc11 of the CC1 terminal 162 decreases from the power supply voltage V+ to a voltage (=Rd×I1) generated at the first resistor 212. The detection circuit 116 can detect that the CC1 terminal 162 is coupled to the sink device 20 in response to the decrease in the voltage Vc11 of the CC1 terminal 162.

The current control circuit 118 controls the magnitude of the current I1 supplied by the first current source 112 and the magnitude of the current I2 supplied by the second current source 114 according to the detection result of the detection circuit 116.

In response to the detection circuit 116 detecting that the CC1 terminal 162 is coupled to the sink device 20, the current control circuit 118 may control the current I2 such that the identification circuit 117 can identify the cable 30. Specifically, the current control circuit 118 may increase the current I2 such that the magnitude of the current I2 becomes a current value (for example, 330 μA or the like) defined by the USB-Type C. As a result, the identification circuit 117 can identify the type of the cable 30.

The identification circuit 117 identifies the type of the cable 30 based on the voltage Vc12 of the CC2 terminal 164. When the CC2 terminal 164 is coupled to the third terminal 304 of the cable 30, the current I2 to the third terminal 304 of the cable 30 flows to the CC2 terminal 164 from the second current source 114. The current I2 flows through the third resistor 312 of the cable 30, whereby the voltage Vc12 (=Ra×I2) according to the resistance value of the third resistor 312 and the magnitude of the current I2 is generated at the CC2 terminal 164. The detection circuit 116 can identify the type (for example, an electronic marked cable or the like) of the cable 30 based on the voltage Vc12.

In response to the detection circuit 116 detecting that the CC1 terminal 162 is coupled to the sink device 20, the current control circuit 118 may control the magnitude of the current I1 such that the sink device 20 can recognize the source device 10. Specifically, the current control circuit 118 increases the current I1 such that the detection circuit 216 of the sink device 20 can detect that the sink device 20 is coupled to the source device 10 or identify the current capability of the source device 10. As a result, the detection circuit 216 can detect that the sink device 20 is coupled to the source device 10 based on the voltage Vc21 (=Rd×I1) of the CC1 terminal. In addition, the detection circuit 216 can identify the current capability of the source device 10 based on the voltage Vc21 of the CC1 terminal.

According to the source device 10 of the present embodiment, the current control circuit 118 is configured to control the magnitude of the current flowing through the CC1 terminal 162 or the magnitude of the current flowing through the CC2 terminal 164 in response to the detection circuit 116 detecting that the CC1 terminal 162 (first terminal) is coupled to the sink device 20. As a result, even when the current flowing through the CC1 terminal 162 or the CC2 terminal 164 is insufficient for identification of the cable 30, notification of current capability, or the like before the coupling between the source device 10 and the sink device 20, it is possible to appropriately perform the identification of the cable 30, the notification of current capability, or the like by controlling these currents after coupling. Furthermore, since the current flowing through the CC1 terminal 162 or the CC2 terminal 164 can be reduced before the coupling between the source device 10 and the sink device 20, unnecessary power consumption can be reduced in a case where only the cable 30 is coupled to the source device 10 or in a case where the CC1 terminal 162 and the CC2 terminal 164 are short-circuited.

Note that the method of coupling the cable 30 is not limited to the example illustrated in FIG. 6. The first terminal 300 of the cable 30 may be coupled to the CC2 terminal 164 of the source device 10, the second terminal 302 of the cable 30 may be coupled to the CC2 terminal 264 of the sink device 20, the third terminal 304 of the cable 30 may be coupled to the CC1 terminal 162 of the source device 10, and the fourth terminal 306 of the cable 30 may be coupled to the CC1 terminal 262 of the sink device 20.

In this case, the current to the sink device 20 flows through the CC2 terminal 164, and the current to the cable 30 for identifying the cable 30 flows through the CC1 terminal 162. The detection circuit 116 detects that the CC2 terminal 164 is coupled to the sink device 20 based on the voltage (specifically, the voltage Vc12 of the CC2 terminal 164) according to the current flowing through the CC2 terminal 164. In response to the detection circuit 116 detecting that the CC2 terminal 164 is coupled to the sink device 20, the current control circuit 118 controls the magnitude of the current flowing through the CC1 terminal 162 or the magnitude of the current flowing through the CC2 terminal 164. Also in this case, as described above, unnecessary power consumption can be reduced.

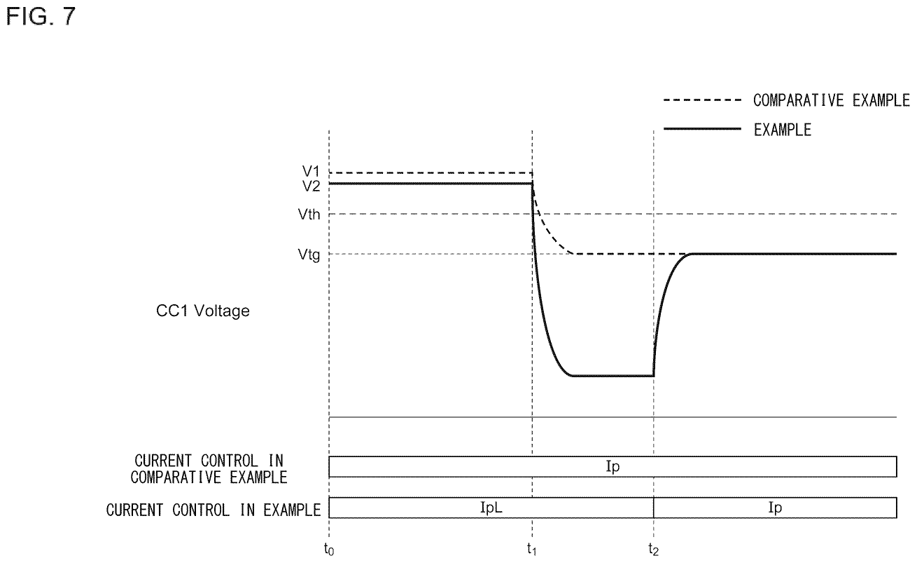

FIG. 7 is a diagram illustrating a timing chart for describing an example of the operation of the source CC circuit according to an example and a comparative example. The source CC circuit according to the example is the source CC circuit 110 according to the above-described embodiment, and the source CC circuit according to the comparative example is the source CC circuit 90 according to the above-described comparative technique. FIG. 7 illustrates a voltage value of the CC1 terminal of the source device and current control of the current source (the first current source and the second current source) for each of the example and the comparative example.

At a timing to, it is assumed that the cable 30 and the sink device 20 are not coupled to the source device in both the example and the comparative example. At this time, it is assumed that the voltage value of the CC1 terminal 162 is V1 in the source device according to the comparative example, and the voltage value of the CC1 terminal 162 is V2 in the source device 10 according to the example. In FIG. 7, V1 is indicated to be higher than V2, but V1 may be substantially the same value as V2.

At the timing to, in the source device according to the comparative example, it is assumed that the first current source 902 and the second current source 904 are controlled such that a current having a current value Ip necessary for identification of the cable 30, detection of coupling between the source device 10 and the sink device 20, notification of current capability, and the like can flow, respectively. Here, it is assumed that the current value Ip is 330 μA which is a standard value of the USB-Type C.

On the other hand, in the source device 10 according to the example, the first current source 112 and the second current source 114 are controlled so as to cause a current value IpL lower than the current value Ip to flow, respectively. Here, it is assumed that the current value IpL is 80 μA which is a standard value of the USB-Type C. The current value IpL is not limited to the standard value of the USB-Type C, and may be, for example, less than 80 μA.

At a timing t₁, in both the example and the comparative example, the source device is coupled to the sink device 20. Here, it is assumed that the CC1 terminal 162 of the source device is coupled to the sink device 20 via the cable 30. Accordingly, in both the example and the comparative example, when the voltage value of the CC1 terminal 162 of the source device decreases and the voltage value of the voltage of the CC1 terminal 162 falls below a threshold voltage Vth, it is detected that the source device is coupled to the sink device 20.

Immediately before a timing t₂, the voltage value of the CC1 terminal 162 is stable in the example and the comparative example. In the comparative example, a current of 330 μA as a standard value flows from the source device to the sink device 20, and the magnitude of the current flowing from the current source of the source device is maintained at Ip. On the other hand, in the example, the magnitude of the current flowing from the current source is increased from IpL to Ip at the timing t₂. As a result, in the example, the voltage value of the CC1 terminal 162 becomes a target voltage Vtg, and the source device can identify the type of the cable 30 and notify the sink device 20 of the current capability. Furthermore, the sink device 20 can detect that it is coupled to the source device 10.

Although the embodiment according to the present disclosure has been described using specific terms, this description is merely an example for assisting understanding, and does not limit the present disclosure or the claims, and the scope of the present disclosure is defined by the claims. Furthermore, not only the embodiments but also embodiments, examples, and modifications not described herein are included in the scope of the present disclosure.

In the above embodiment, an example has been described in which the current flowing through each of the CC1 terminal 162 and the CC2 terminal 164 of the source device 10 is controlled using the two current sources (the first current source 112 and the second current source 114). For example, the present disclosure is not limited thereto, and the current flowing through each of the CC1 terminal 162 and the CC2 terminal 164 may be controlled by replacing each of the first current source 112 and the second current source 114 with a variable resistor (pull-up resistor) and adjusting the resistance value of the variable resistor.

In the above embodiment, an example in which the source device 10 and the sink device 20 are coupled via the cable 30 has been mainly described. The present disclosure is not limited thereto, and the source device 10 and the sink device 20 may be directly coupled without a cable.

### Supplement

The technique disclosed in the present specification can be understood as follows in one aspect.

### Item 1

A source device for supplying power to a sink device, the source device including:
a first terminal through which a current to the sink device flows when the first terminal is coupled to the sink device;
a second terminal through which a current to a cable for identifying the cable flows when the second terminal is coupled to the cable;
a detection circuit configured to detect that the first terminal is coupled to the sink device based on a voltage according to the current flowing through the first terminal; and
a current control circuit configured to control a magnitude of the current flowing through the first terminal or a magnitude of the current flowing through the second terminal in response to the detection circuit detecting that the first terminal is coupled to the sink device.

### Item 2

The source device according to item 1, in which
when the first terminal is coupled to the sink device via the cable and the second terminal is coupled to the cable, the current control circuit increases the current flowing through the second terminal such that the source device is capable of identifying the cable in response to the detection circuit detecting that the first terminal is coupled to the sink device.

### Item 3

The source device according to item 1 or 2, in which
the current control circuit increases the current flowing through the first terminal such that the sink device is capable of recognizing the source device in response to the detection circuit detecting that the first terminal is coupled to the sink device.

### Item 4

The source device according to any one of items 1 to 3, in which
the first terminal is a terminal through which a current to the sink device flows when the first terminal is coupled to the sink device,
the second terminal is a terminal through which a current to the cable for identifying the cable flows when the second terminal is coupled to the cable,
the detection circuit detects that the second terminal is coupled to the sink device based on a voltage according to the current flowing through the second terminal, and
the current control circuit controls the magnitude of the current flowing through the first terminal or the magnitude of the current flowing through the second terminal in response to the detection circuit detecting that the second terminal is coupled to the sink device.

### Item 5

The source device according to any one of items 1 to 4, further including:
a first current source configured to supply a current to the first terminal; and
a second current source configured to supply a current to the second terminal, in which
the current control circuit controls a magnitude of the current supplied from the first current source to the first terminal or a magnitude of the current supplied from the second current source to the second terminal in response to the detection circuit detecting that the first terminal is coupled to the sink device.

What is claimed is:

1. A source device for supplying power to a sink device, the source device comprising:
a first terminal through which a current to the sink device flows when the first terminal is coupled to the sink device;
a second terminal through which a current to a cable for identifying the cable flows when the second terminal is coupled to the cable;
a detection circuit configured to detect that the first terminal is coupled to the sink device based on a voltage according to the current flowing through the first terminal; and
a current control circuit configured to control a magnitude of the current flowing through the first terminal or a magnitude of the current flowing through the second terminal in response to the detection circuit detecting that the first terminal is coupled to the sink device.

2. The source device according to claim 1, wherein
when the first terminal is coupled to the sink device via the cable and the second terminal is coupled to the cable, the current control circuit increases the current flowing through the second terminal such that the source device is capable of identifying the cable in response to the detection circuit detecting that the first terminal is coupled to the sink device.

3. The source device according to claim 1, wherein
the current control circuit increases the current flowing through the first terminal such that the sink device is capable of recognizing the source device in response to the detection circuit detecting that the first terminal is coupled to the sink device.

4. The source device according to claim 1, wherein
the first terminal is a terminal through which a current to the sink device flows when the first terminal is coupled to the sink device,
the second terminal is a terminal through which a current to the cable for identifying the cable flows when the second terminal is coupled to the cable,
the detection circuit detects that the second terminal is coupled to the sink device based on a voltage according to the current flowing through the second terminal, and
the current control circuit controls the magnitude of the current flowing through the first terminal or the magnitude of the current flowing through the second terminal in response to the detection circuit detecting that the second terminal is coupled to the sink device.

5. The source device according to claim 1, further comprising:
a first current source configured to supply a current to the first terminal; and
a second current source configured to supply a current to the second terminal, wherein
the current control circuit controls a magnitude of the current supplied from the first current source to the first terminal or a magnitude of the current supplied from the second current source to the second terminal in response to the detection circuit detecting that the first terminal is coupled to the sink device.
